(19) United States
(12) Patent Application Publication
(10) Pub. No.: US 2009/0117805 A1
(43) Pub. Date: May 7, 2009

(54) Polyethylene Multi-Filament Yarn

(75) Inventors: Joseph Arnold Paul Maria Japm Simmelink, Cadier En Keer (NL); Roelof R. Marissen, Born (NL); Harm H. Werff van der, Bunde (NL)

Correspondence Address: NIXON & VANDERHYE, PC, 901 NORTH GLEBE ROAD, 11TH FLOOR, ARLINGTON, VA, 22203, US

(73) Assignee: DSM IP ASSESTS B.V., Heerlen (NL)

(21) Appl. No.: 11/988,881

(22) PCT Filed: Jun. 28, 2006
(86) PCT No.: PCT/EP2006/006273

§ 371 Date: May 5, 2008

(30) Foreign Application Priority Data
Jul. 18, 2005 (EP) 05076648.4

(51) Int. Cl. D01F 6/04; B32B 5/26; C08K 5/05

(52) U.S. Cl. 442/392; 264/205; 524/379

(57) ABSTRACT

The invention relates to a process for making a polyethylene multifilament yarn comprising the steps of a) spinning multiple filaments from a solution comprising between 0.5 and 30 mass % of ultra high molecular weight polyethylene in a solvent; b) cooling the filament obtained to form gel filaments; c) removing at least partly the solvent from the gel filaments; d) drawing the filaments in at least one drawing step before, during or after removing the solvent, wherein the solution of step a) further comprises between 0.1 and 7 mass % of a sorbitol derivative and at step d) the filaments are drawn with a draw ratio of more than 15 to a strength of at least 1 GPa. The invention further relates to a high performance polyethylene multifilament yarn having a strength of at least 1 GPa, wherein the yarn comprises between 0.1 and 5 mass % of a sorbitol derivative.

The invention relates to a process for making a polyethylene multi-filament yarn comprising the steps of
a) spinning at least one filament from a solution comprising between 0.5 and 30 mass % of ultra high molecular weight polyethylene in a solvent;
b) cooling the filament obtained to form a gel filament;
c) removing at least partly the solvent from the gel filament;
d) drawing the filament in at least one drawing step before, during or after removing solvent.

The invention further relates to a multi-filament ultra high molecular weight polyethylene yarn having a tensile strength of at least 1 GPa.

Such a spinning process is generally referred to as a gel spinning process. Gel spinning of polyethylene with a relative viscosity of more than 5 dl/g (ultra high molecular weight polyethylene; UHMWPE) has been described in various publications, including EP 0205960 A, EP 0213208 A1, U.S. Pat. No. 4,413,110, WO 01/73173 A1, and Advanced Fiber Spinning Technology, Ed. T. Nakajima, Woodhead Publ. Ltd (1994), ISBN 1-855-73182-7, and references cited therein.

In general high performance polyethylene yarns are produced in a process that starts by mixing UHMWPE at elevated temperature with a solvent. The thus formed solution is then spun to a multi filament yarn. This yarn is cooled to below a temperature at which crystallization of polyethylene in the solvents occurs, thus forming solvent-containing gel filaments. To remove the solvent, the gel can be dried or extracted. Subsequently, or during removing of the solvent, the gel can be drawn at a temperature low enough to prevent the polyethylene to re-dissolve.

Solvent removal and drawing can take place simultaneously, such that a last drawing step can be carried out when the yarn is substantially free of solvent.

The final strength of a yarn resulting from this process depends on:
Molecular weight of the UHMWPE,
Concentration of UHMWPE in the solvent,
Molecular architecture of the UHMWPE like the presence of side groups,
Solvent,
Possible drawing of the spun solution,
Rate of cooling during crystallization,
Number of filaments per yarn,
Amount of drawing, drawing rate and temperature profile during drawing of the gel.

In a production environment the strength of a multifilament yarn obtained is generally a commercial compromise. The fact that a single filament with a strength of 7 GPa, can be made on a laboratory scale, does not mean that a yarn of similar strength can be made in a commercial production environment with the present day technology. In commercial processes a balance has to be found between variables like the choice of molecular weight, UHMWPE concentration in the solvent, the production rate and the degree and rate of drawing, the length of drying ovens and the reliability of the process.

This means that a higher strength can be obtained in a production environment, but generally only at the expense of a lower output capacity, due to either a solution of lower concentration, or an increased yarn rupture percentage when the rate and degree of drawing are increased. The other way around, output capacity can be increased at the expense of a lower strength, e.g. by increasing the concentration of polyethylene in the solution. Therefore, there is a need of e.g. increasing the strength of the yarn without disturbing the balance between other parameters like the output capacity.

Surprisingly this can be obtained by the characterizing feature of claim 1.

The use of sorbitol derivatives to increase modulus is known from WO2004/076540, where it is specifically used to reduce the gelling time of an i-PP solution in decalin, a material combination that normally does not form a gel at all. However, gelation of a UHMWPE solution in for example decalin or paraffin is extremely fast, as can be seen from the sharp freezing line, even at high speed spinning. Furthermore, an increase of the modulus as such is not aimed at in the present invention, which is rather aiming at an increase of tensile strength.

A method of making shaped articles is known from WO 03/087217, wherein the articles comprise UHMWPE mixed with a processing oil and a lubricant, the lubricant being selected from the group consisting of among other components also sorbitol esters and ethoxylated sorbitol esters. However, the method of WO 03/087217 is designed to produce shaped articles in the form of sheets or films. The method does not disclose the production of multifilament yarns having a high tensile strength and being drawn at least 15 times. Furthermore, the amount of lubricant used in the process of WO 03/087217 is much higher than the amount of sorbitol derivative used in the process according to the present invention.

Within the context of the present invention a yarn is understood to be an elongate body comprising multiple individual filaments having cross-sectional dimensions much smaller than their length. The filaments are understood to be continuous filaments; that is being of virtually indefinite length. The filaments may have cross-sections of various geometrical or irregular shapes. Filaments within a yarn may be parallel or entangled to one another; the yarn may be linear, twisted or otherwise departed from a linear configuration.

In the present invention the solution of UHMWPE comprises between 0.1 and 7 mass % with respect to the amount of UHMWPE of a sorbitol derivative. Suitable sorbitol derivatives are for instance 1, 3-2,4-di (benzylidene)-D-sorbitol (MILLAD 3905, Milliken Chemical Co.; IRGACLEAR D, Ciba Specialty Chemicals); 1, 3-2,4-di (4-tolylidene)-D-sorbitol (MILLAD 3940, Milliken Chemical Co.; NC-6, Mitsui Petrochemical Industries, Ltd.); 1, 3-2,4-(3,4-dimethylbenzylidene)-Dsorbitol (MILLAD 3988, Milliken Chemical Co.); 1, 3-2,4-di (4-ethylbenzylidene)-D-sorbitol (NC-4, Mitsui Petrochemical Industries, Ltd.). Below 0.1 mass % of a sorbitol derivative no significant increase of strength of the yarn was found. More than 7 mass % of a sorbitol derivative caused an unacceptable deposition thereof on the stretching equipment. Preferably, the amount of sorbitol is at most 5 mass %, more preferably at most 4, 3, 2 or at most 1 mass %, in order to make high strength yarn in a stable process; the amount of sorbitol is preferably at least 0.15, 0.20, 0.25 or 0.30 mass %.

It is furthermore well known, that spinning of high-strength multifilament yarn becomes increasingly difficult the higher the number of filaments in the yarn as spun, one of the likely reasons being differences in spinning and drawing conditions, and subsequently in properties, occurring between filaments. For a polyethylene multifilament yarn spinning process to be commercially viable on industrial scale, it is important that such process can be run continuously without interruptions and with high throughput rate, with a high number of filaments in the as-spun yarn.

The ultra-high molar mass polyethylene applied in the process according to the invention has an intrinsic viscosity (IV, as measured on a solution in decalin at 135° C.) of between about 8 and 40 dl/g, preferably between 10 and 30, or 12 and 28, more preferably between 15 and 25 dl/g, to provide a balance between processability of the solution to be spun and mechanical properties of the obtained filaments. Intrinsic viscosity is a measure for molar mass (also called molecular weight) that can more easily be determined than actual molar mass parameters like Mₙ and M_{w}. There are several empirical relations between IV and M_{w}, but such relation is dependent on molar mass distribution. Based on the equation M_{w}=5.37*10⁴ [IV]^{1.37} (see EP 0504954 A1) an IV of 4 or 8 dl/g would be equivalent to M_{w} of about 360 or 930 kg/mol, respectively. It is well known that during processing of a polymer at elevated temperature generally some chain scission occurs, leading to a lower molar mass of the product obtained versus that of the starting polymer. It is found that upon gel spinning of UHMWPE an IV drop of about 1-3 g/dl may occur, depending on starting molar mass and processing conditions.

Preferably, the UHMWPE is a linear polyethylene with less than one branch per 100 carbon atoms, and preferably less than one branch per 300 carbon atoms; a branch or side chain or chain branch usually containing at least 10 carbon atoms. The linear polyethylene may further contain up to 5 mol % of one or more comonomers, such as alkenes like propylene, butene, pentene, 4-methylpentene or octene.

In a preferred embodiment, the UHMWPE contains a small amount, preferably at least 0.2, or at least 0.3 per 1000 carbon atoms, of relatively small groups as pending side groups, preferably a C1-C4 alkyl group. It is found that by applying a polymer containing a certain amount of such groups results in yarns having an advantageous combination of high strength and further improved creep behaviour. Too large a side group, or too high an amount of side groups, however, negatively affects the processing and especially the drawing behaviour of the filaments. For this reason, the UHMWPE preferably contains methyl or ethyl side groups, more preferably methyl side groups. The amount of side groups is preferably at most 20, more preferably at most 10, 5 or at most 3 per 1000 carbon atoms.

Suitable solvents for this spinning process are known, and include for example paraffin oil or wax, xylene, mineral oil, kerosenes or decalin. Spinning solvent can be removed by evaporation, extraction, or by a combination of evaporation and extraction routes.

The UHMWPE solution that is applied in the process according to the invention may further contain small amounts, generally less than 5 mass %, preferably less than 3 mass % of customary additives, such as anti-oxidants, thermal stabilizers, colorants, flow promoters, etc. The UHMWPE can be a single polymer grade, but also a mixture of two or more different polyethylene grades, e.g. differing in IV or molar mass distribution, and/or type and number of comonomers or side groups.

In the process according to the invention any of the known solvents suitable for gel spinning of UHMWPE can be used as solvent for making the polyethylene solution, for example paraffin wax, paraffin oil or mineral oil, kerosenes, decalin, tetralin, or a mixture thereof. It is found that the present process is especially advantageous for relatively volatile solvents, preferably solvents having a boiling point at atmospheric conditions of less than 275° C., more preferably less than 250 or 225° C. Suitable examples include decalin, tetralin, and several kerosene grades. The solution of UHMWPE in solvent can be made using known methods. Preferably, a twin-screw extruder is applied to make a homogeneous solution from a UHMWPE/solvent slurry.

The solution is preferably fed to the spinplate at constant flow rate with metering pumps. The concentration of the UHMWPE solution is between 0.5 and 25 mass %, with a lower concentration being preferred the higher the molar mass of the polyethylene is. Preferably, the concentration is between 3 and 15 mass % for UHMWPE with IV in the range 15-25 dl/g.

The UHMWPE solution is preferably of substantially constant composition over time, because this further improves processing stability and results in yarn of more constant quality over time. With substantially constant composition it is meant that parameters like UHMWPE chemical composition and molar mass, and concentration of UHMWPE in the solution vary only within a certain range around a chosen value.

Cooling of the fluid filaments into solvent-containing gel filaments may be performed with a gas flow, or by quenching the filament in a liquid cooling bath after passing an air-gap, the bath preferably containing a non-solvent for the UHMWPE solution. If gas cooling is applied, the air-gap is the length in air before the filaments are solidified. Preferably a liquid quench-bath is applied in combination with an air-gap, the advantage being that drawing conditions are better defined and controlled than by gas cooling. Although called air-gap, the atmosphere can be different than air; e.g. as a result of an inert gas like nitrogen flowing, or as a result of solvent evaporating from filaments. Preferable, there is no forced gas flow, or only of low flow rate. In a preferred embodiment, the filaments are quenched in a bath containing a cooling liquid, which liquid is not miscible with the solvent, the temperature of which is controlled, and which flows along the filaments at least at the location where the fluid filaments enter the quench bath. The spun filaments can be drawn before they are solidified into gel filaments; for example by using a higher take-up speed than the rate of solution spun from the spinneret. Such drawing on fluid filaments, with a draw ratio indicated as DR_{fluid}, is also often called draw down.

Solvent removal can be performed by known methods, for example by evaporating a relatively volatile solvent, by using an extraction liquid, or by a combination of both methods.

The process for making a polyethylene yarn according to the invention further comprises, in addition to drawing the solution filaments, drawing the filaments in at least one drawing step performed on the semi-solid or gel filaments and/or on solid filaments after cooling and at least partial removal of solvent, with a draw ratio of at least 4. Preferably, drawing is performed in more than two steps, and preferably at different temperatures with an increasing profile between about 120 and 155° C. A 3-step draw ratio applied on (semi-) solid filaments is represented as DRs_{solid}=DR_{solid1}*DR_{solid 2}*DR_{solid 3}; i.e. it is composed of the draw ratios applied in each drawing step.

It is found that a draw ratio DR_{solid} of upto about 35 can be applied, to reach the highest tensile properties of the yarn obtainable for a given DR_{fluid}. In the process of the invention the filaments are drawn in at least one drawing step with a draw ratio of more than 15. The process according to the invention thus results in a multifilament polyethylene yarn not only showing higher tensile strength than known multifilament yarns, but also less fluffing (resulting from the presence of broken filaments); especially if draw ratios have been optimised.

The process according to the invention may further comprise additional steps known in the art, like for example applying a spin finish or sizing agent to the yarn.

Preferably, the said yarn is an as-spun or as-produced yarn; meaning the yarn is the direct product of a spinning and drawing process, and is not made by assembling separately produced yarns containing less filaments. Of course, the as-produced yarn according to the invention can further be assembled into yarns, or ropes etc, of higher titer or linear density.

Such high-strength yarn is very useful for various applications, like making of heavy-duty ropes and cables, or for making ballistic-resistant composites offering improved protection level, or reduced weight. Yarn of relatively low titer, containing for example from 5 to 300 filaments, but of extremely high strength is i.e. very suited for making high-strength surgical sutures and cables, or other medical implants. For medical applications the amount of other components or foreign materials in the yarn is very important, in addition to its mechanical properties. The invention therefore also specifically relates to a polyethylene multifilament yarn according to the invention containing less than 150 ppm of residual solvent, specifically of solvent having a boiling point at atmospheric conditions of less than 275° C., preferably containing less than 100, 75, or even less than 50 ppm of solvent, and to medical implants containing such yarn.

The invention further relates to a high-performance polyethylene multifilament (HPPE) yarn containing at least 20 filaments, having a strength of at least 1 GPa, and comprising between 0.1 and 5 mass % of a sorbitol. Preferably, the HPPE yarn has a strength of at least 2, 3, or at least 3.5 GPa.

The invention further relates to various semi-finished and end-use articles containing the high-performance polyethylene multi-filament yarn according to the invention, or a high-performance polyethylene multi-filament yarn obtainable by the process according to the invention. Examples of such articles include various ropes and cords, fishing nets, sports equipment, medical implants like suture and cables, and ballistic-resistant composites. In most of these applications the tensile strength of the yarn is an essential parameter determining performance of the article.

Ropes especially include heavy-duty ropes for application in marine and offshore operations, like anchor handling, seismic operations, mooring of drilling rigs and production platforms, and towing. Preferably, such ropes contain at least 50 mass % of the yarn according to the invention, more preferably at least 75, or even 90 mass %. Most preferably, the rope consists essentially of HPPE yarn according to the invention. Such products also show improved performance, like reduced creep and longer time to rupture under continuous loading conditions, in addition to higher strength. Products containing high amounts of HPPE yarn have a low relative density; possibly lower than water, which is an advantage in marine and offshore applications.

The invention further relates to a multi-layer ballistic-resistant assembly containing a plurality of monolayers comprising HPPE yarn according to the invention, and to ballistic-resistant articles comprising such an assembly. The HPPE yarn can be present in various forms in a monolayer, e.g. as woven and non-woven fabrics. Preferably, the monolayers contain unidirectionally oriented HPPE filaments; with the fibre direction in each monolayer being rotated with respect to the fibre direction in an adjacent monolayer. The monolayers may further comprise a binder material, basically to hold the filaments together. The binder material can have been applied by various techniques; for example as a film, as a transverse bonding strip or fibres (transverse with respect to the unidirectional filaments), or by impregnating and/or embedding the filaments with a matrix, e.g. with a solution or dispersion of matrix material in a liquid. The amount of binder material is preferably less than 30 mass % based on the mass of the layer, more preferably less than 20 or 15 mass %. The monolayers may further comprise small amounts of auxiliary components, and may comprise other filaments. Preferably the monolayers only comprise HPPE filaments as reinforcing fibres. Such monolayers are therefore also referred to as monolayers consisting essentially of HPPE filaments.

The multi-layer ballistic-resistant assembly can also be an assembly of at least two preformed sheet layers, a sheet layer comprising at least two monolayers comprising high-performance fibres and a binder material, and optionally other layers, like a film or fabric; that have been consolidated or attached to each other. Such multi-layer ballistic-resistant assemblies or panels, and their manufacture are known in the art, for example from U.S. Pat. No. 4,916,000, U.S. Pat. No. 4,623,574, EP 0705162 A1 or EP 0833742 A1.

For so-called hard ballistic applications like vehicle armouring, rigid panels that have been (compression-) moulded from a plurality of monolayers containing HPPE yarn are generally applied. For soft ballistic applications like body armour, flexible panels assembled from a plurality of mono-layers containing HPPE yarn, e.g. by stacking mono-layers or preformed sheets and securing the stack by for example stitching at the corners or around the edges, or by placing inside an envelope, are preferred.

The invention is further elucidated with following non-limiting experiments.

### EXAMPLE 1

An 8 mass % solution of a UHPE polymer, further comprising 0.35 mass % 1, 3-2,4-di (4-tolylidene)-D-sorbitol (MILLAD 3940, Milliken Chemical Co.) with respect to the UHMWPE, the UHMWPE having less than 0.3 side groups per 1000 per carbon atoms and an IV of 19.8 dl/g, in decalin was extruded with a 25 mm twin screw extruder equipped with a gear-pump at a temperature setting of 180° C. through a spinplate having 64 spinholes into an air-gap with a rate of 2.2 g/min per hole. Further relevant data is shown in Table 1. The water in the quench bath was kept at 30-40° C., and had a flow rate of about 3 cm/s near the filaments. Solid-state drawing was performed in two steps, first with a temperature gradient of about 110-140° C. and than at about 151° C. The total draw ratio DRₒᵥₑᵣₐₗₗ (=DR_{fluid}*DR_{solid}) amounted 2160. The amount of sorbitol in the fiber was 0.23 mass %.

TABLE 1

| | | Air-gap | | | | TS | eab |
|---|---|---|---|---|---|---|---|
| | n | (mm) | DR_{fluid} | DR_{solid} | DRₒᵥₑᵣₐₗₗ | (GPa) | (%) |
| Ex 1 | 64 | 20 | 108 | 20 | 2160 | 4.3 | 3.28 |
| comp A | 64 | 20 | 108 | 20 | 2160 | 3.7 | 3.27 |

### Comparative Experiment A

In this experiment was carried out under the conditions of Example 1, with an UHMWPE solution comprising no sorbitol.

The measured tensile strength of the sorbitol comprising fibre was significantly higher than for the fibre from Comparative Example A.

### Tensile Testing

Tensile testing was carried out with a gauge length of 278 mm and a crosshead speed of 100 mm/min. Filament denier is determined by weighing 1 m of filament on a micro-balance, before and after a series of 3 individual tensile tests. In total, 12 filaments were tested for each sample.

### Methods

IV: the Intrinsic Viscosity is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration;
Side chains: the number of side chains in a UHMWPE sample is determined by FTIR on a 2 mm thick compression moulded film, by quantifying the absorption at 1375 cm⁻¹ using a calibration curve based on NMR measurements (as in e.g. EP 0269151);
Tensile properties: tensile strength (or strength) and elongation at break (or eab) are defined and determined on multifilament yarns with a procedure in accordance with ASTM D885M, using a nominal gauge length of the fibre of 500 mm, a crosshead speed of 50%/min and Instron 2714 clamps, of type Fibre Grip D5618C. For calculation of the strength, the tensile forces measured are divided by the titre, as determined by weighing 10 metres of fibre; values in GPa are calculated assuming a density of 0.97 g/cm³;

1-4. (canceled)

5. Process for making a polyethylene multi-filament yarn comprising the steps of
a) spinning multiple filaments from a solution comprising between 0.5 and 30 mass % of ultra high molecular weight polyethylene in a solvent;
b) cooling the filament obtained to form gel filaments;
c) removing at least partly the solvent from the gel filaments;
d) drawing the filaments in at least one drawing step before, during or after removing the solvent, characterized in that the solution of step a) further comprises between 0.1 and 7 mass % of a sorbitol derivative and at step d) the filaments are drawn with a draw ratio of more than 15 to a strength of at least 1 GPa.

6. High performance polyethylene multi-filament yarn containing at least 20 filaments having a strength of at least 1 GPa, characterized in that the yarn comprises between 0.1 and 5 mass % of a sorbitol derivative.

7. Yarn according to claim 6, comprising between 0.1 and 2 mass % of a sorbitol derivative.

8. Yarn according to claim 6, comprising between 0.2 and 0.4 mass % of a sorbitol derivative.

9. Semi-finished and end-use articles containing the high performance polyethylene multi-filament yarn of claim 6.

10. Rope containing the high performance polyethylene multi-filament yarn of claim 6.

11. Multilayer ballistic-resistant assembly containing a plurality of monolayers comprising the high performance polyethylene multi-filament yarn of claim 6.
